(19) United States
(12) Patent Application Publication
(10) Pub. No.: US 2024/0100530 A1
(43) Pub. Date: Mar. 28, 2024

(54) SAMPLE PREPARATION BLISTER PACKS

(71) Applicant: HP HEALTH SOLUTIONS INC., Palo Alto, CA (US)

(72) Inventors: Paul Mark Haines, Corvallis, OR (US); John Michael Lahmann, Corvallis, OR (US); Kenneth James Faase, Corvallis, OR (US)

(73) Assignee: HP Health Solutions Inc., Palo Alto, CA (US)

(21) Appl. No.: 18/265,658

(22) PCT Filed: Mar. 21, 2021
(86) PCT No.: PCT/US2021/020280

§ 371 Date: Jun. 6, 2023

Related U.S. Application Data
(63) Continuation-in-part of application No. PCT/US2020/063778, filed on Dec. 8, 2020.

(51) Int. Cl. B01L 3/00

(52) U.S. Cl. CPC B01L 3/523; B01L 2200/025; B01L 2200/04; B01L 2200/16; B01L 2300/047; B01L 2300/087; B01L 2300/10; B01L 2400/0683

(57) ABSTRACT

A sample preparation blister pack can include a plurality of reservoirs formed as blisters. The reservoirs can have an actuatable barrier layer and a seal barrier layer with contents of the reservoirs between the actuatable barrier layer and the seal barrier layer. The contents can be to facilitate isolating a biological component from a biological sample. The individual reservoirs can be adapted to release the contents through the seal barrier layer upon actuation of the actuatable barrier layer. The blister pack can have a width and a length and the reservoirs can be lined up along the length. In this example, a first reservoir contains an inert mechanical fluid and a second reservoir contains a reagent, a buffer, or a combination thereof.

### BACKGROUND

In biomedical, chemical, and environmental testing, isolating a component of interest from a sample fluid can be useful. Such separations can permit analysis or amplification of a component of interest. As the quantity of available assays for components increases, so does the demand for the ability to isolate components of interest from sample fluids. Fluidic devices can be used for these applications, among others. In some examples, microfluidic devices can be used to prepare and process samples with small volumes.

### BRIEF DESCRIPTION OF THE DRAWINGS

FIGS. 1A-1C illustrate an example sample preparation blister pack in accordance with the present disclosure;

FIG. 2 illustrates another example sample preparation blister pack in accordance with the present disclosure:

FIGS. 3A-3H illustrate an example sample preparation cartridge module being used to prepare a biological sample in accordance with the present disclosure; and

FIG. 4 illustrates a method of making an example sample preparation cartridge module in accordance with the present disclosure.

### DETAILED DESCRIPTION

The present disclosure describes sample preparation blister packs and sample preparation cartridge modules that can be used in sample preparation devices for isolating biological components from a biological sample. The blister packs can include various fluids that are useful in processes involving biological samples. Cartridge modules can include the blister pack and channels for directing the various fluids. In certain examples, the blister packs and cartridge modules can be used for polymerase chain reaction (PCR) assays. PCR assays are processes that can rapidly copy millions to billions of copies of a very small nucleic acid sample, such as DNA or RNA. PCR can be used for many different application, included sequencing genes, diagnosing viruses, identifying cancers, and others. In the PCR process, a small sample of nucleic acid is combined with reactants that can form copies of the nucleic acid. Because the volumes of samples fluid and reactant involved in this process are very small, it can be beneficial to use sample preparation devices with small reservoirs and fluidic channels such as those described herein. Additionally, PCR processes involve reactants (e.g., PCR master mix) that can degrade quickly when in a liquid solution. These reactants can often be kept as dried reactant pellets. In some examples, the blister packs described herein can include a blister reservoir of a buffer for reconstituting such dried reactants. The blister pack can also include other fluids that are useful a sample preparation process. In particular examples, the blister pack can include a reservoir of an inert mechanical fluid. This fluid can be chemically inert with respect to the biological sample and other reactants involved in sample preparation. However, the inert mechanical fluid can be used for a mechanical purpose such as pushing other fluids through channels or separating fluids one from another. In further examples, the blister packs and cartridge modules described herein can be a part of an automated process, in which the nucleic acid can be separated from a biological sample and mixed with the PCR master mix reactants with limited human interaction. For example, the process of separating nucleic acids from the biological sample, reconstituting the PCR master mix reactants, and mixing the reconstituted reactants with the nucleic acid can be performed by an automated system.

In accordance with this, in one example, a sample preparation blister pack includes a plurality of reservoirs formed as blisters having an actuatable barrier layer and a seal barrier layer. The contents of the reservoirs are between the actuatable barrier layer and the seal barrier layer. The contents are to facilitate isolating a biological component from a biological sample. Individual reservoirs are adapted to release the contents through the seal barrier layer upon actuation of the actuatable barrier layer. The blister pack has a width and a length and the reservoirs are lined up along the length. A first reservoir contains an inert mechanical fluid, and a second reservoir contains a reagent, a buffer, or a combination thereof. In some examples, the width of the blister pack can be relatively narrow as compared to the length. In other examples, the inert mechanical fluid can be a non-Newtonian plugging fluid. In still other examples, the inert mechanical fluid can be a gas. In a particular example, the inert mechanical fluid can be a non-Newtonian plugging fluid and the sample preparation blister pack can also include a third reservoir containing a gas. In certain examples, the seal barrier layer can include a plurality of opening features, wherein individual opening features are adapted to provide an opening to release contents of the individual reservoirs into a sample preparation cartridge channel upon actuation of the actuatable barrier adjacent to the respective individual reservoirs, wherein the plurality of opening features are lined up along the length of the blister pack. In particular examples, the seal barrier layer can include pre-shaped openings.

In another specific example, a sample preparation blister pack includes a plurality of reservoirs formed as blisters having an actuatable barrier layer and a seal barrier layer. The individual reservoirs contain a fluid between the actuatable barrier layer and the seal barrier layer. The individual reservoirs are adapted to release the fluid through the seal barrier layer upon actuation of the actuatable barrier layer. The plurality of reservoirs includes a reservoir containing an inert mechanical fluid, and a liquid reservoir containing a liquid including a reagent, a buffer, or a combination thereof. In certain examples, the reservoir containing the inert mechanical fluid can be a non-Newtonian plugging fluid reservoir containing a non-Newtonian plugging fluid. In other examples, the reservoir containing the inert mechanical fluid can be a gas reservoir containing a gas. In some examples, the actuatable barrier layer includes aluminum foil that deforms when actuated. In further examples, the liquid reservoir can be a wash buffer reservoir containing a wash buffer. In still further examples, the plurality of fluid reservoirs can also include a reconstitution buffer reservoir containing reconstitution buffer for reconstituting a lyophilized master mix reagent. In another example, the gas contained by the gas reservoir can be air. In a further example, a hole can be preformed in the seal barrier layer of the gas reservoir. In certain examples, the sample preparation blister pack can also include a label layer affixed on the seal barrier layer, wherein the label layer includes individual openings at the individual reservoirs to admit fluids released from the individual reservoirs. In further examples, the sample preparation blister pack can also include a pressure-sensitive adhesive layer on the label layer opposite from the seal barrier layer, wherein the pressure-sensitive adhesive layer includes individual openings aligned with the individual openings of the label layer and a supply channel connected to an individual opening having a width greater than a width of the supply channel. In still further examples, the non-Newtonian plugging fluid can be a Bingham plastic, a viscoplastic, or a shear thinning fluid.

The present disclosure also describes sample preparation cartridge modules. In one example, a sample preparation cartridge module includes a capillary output channel, a cartridge wall including a plurality of supply channels fluidly connected to the capillary output channel; and a blister pack affixed to the cartridge wall. The blister pack includes a plurality of reservoirs formed as blisters having an actuatable barrier layer and a seal barrier layer. The individual reservoirs contain a fluid between the actuatable barrier layer and the seal barrier layer. The individual reservoirs are adapted to release the fluid through the seal barrier layer into individual supply channels upon actuation of the actuatable barrier layer. The plurality of reservoirs includes a reservoir containing an inert mechanical fluid, and a liquid reservoir containing a liquid including a reagent, a buffer, or a combination thereof. In some examples, the reservoir containing the inert mechanical fluid can be a gas reservoir containing a gas, and the gas reservoir can be connected to the capillary output channel by a supply channel such that fluid within the capillary output channel is ejected by the gas when the actuatable barrier of the gas reservoir is actuated. In other examples, the reservoir containing the inert mechanical fluid can be a non-Newtonian plugging fluid reservoir containing a non-Newtonian plugging fluid. In further examples, the liquid reservoir can be a wash buffer reservoir containing a wash buffer, and the plurality of fluid reservoirs can also include a reconstitution buffer reservoir containing reconstitution buffer for reconstituting a lyophilized master mix reagent, and the plurality of supply channels can include a reconstitution buffer supply channel connected to the reconstitution buffer reservoir and having a lyophilized master mix reagent held within the reconstitution buffer supply channel.

The present disclosure also describes methods of making sample preparation cartridge modules. In one example, a method of making a sample preparation cartridge module includes affixing a blister pack onto a cartridge wall of a cartridge including a capillary output channel and the cartridge wall. The cartridge wall includes a plurality of supply channels fluidly connected to the capillary output channel. The blister pack includes a plurality of reservoirs formed as blisters having an actuatable barrier layer and a seal barrier layer. The individual reservoirs contain a fluid between the actuatable barrier layer and the seal barrier layer. The individual reservoirs are adapted to release the fluid through the seal barrier layer into individual supply channels upon actuation of the actuatable barrier layer. The plurality of reservoirs includes a reservoir containing an inert mechanical fluid, and a liquid reservoir containing a liquid including a reagent, a buffer, or a combination thereof. In some examples, the blister pack can also include a label layer affixed on the seal barrier layer, wherein the label layer includes individual openings at the individual reservoirs to admit fluids released from the individual reservoirs, and wherein affixing the blister pack onto the cartridge wall is performed using a pressure-sensitive adhesive layer including individual openings aligned with the individual openings of the label layer, wherein the pressure-sensitive adhesive layer further includes a supply channel opening aligned with a supply channel of the cartridge wall. In other examples, the liquid reservoir can be a wash buffer reservoir containing a wash buffer, and the plurality of fluid reservoirs can also include a reconstitution buffer reservoir containing reconstitution buffer for reconstituting a lyophilized master mix reagent, and the plurality of supply channels can include a reconstitution buffer supply channel connected to the reconstitution buffer reservoir and having a lyophilized master mix reagent held within the reconstitution buffer supply channel.

The sample preparation blister packs and sample preparation cartridge modules described herein can be used in sample preparation devices to prepare a biological sample, in some examples. The sample preparation devices can be used to separate a particular biological component from a biological sample and add a reactant to the biological component. Some reactants may be subject to degradation when the reactants are prepared in a solution for use in a particular chemical reaction. Certain types of reactants are kept in a more stable state, such as in a dry state, for longer periods of time. When such dry reactants are mixed with liquid to form a solution, the reactants may begin to degrade quickly. Accordingly, it can be useful to keep the liquid and the reactants separate until just before use. In the present disclosure, the liquid that is mixed with the reactant is referred to as a “buffer.” The buffer can simply be water in some examples, or the buffer can include other ingredients such as salts, surfactants, pH controlling compounds, and others. The ingredients in the buffer can be appropriate for mixing with the reactant when preparing the reactant to be used in a reaction. In some examples, a blister reservoir in the blister pack can contain the buffer. Thus, the blister pack can provide a convenient way to keep the buffer and reactant separate. The blister pack reservoir can also provide a precise amount of buffer to mix with the reactant.

In certain examples, the sample preparation device can be used for sample analysis processes such as nucleic acid amplification techniques. Nucleic acid amplification can include PCR assays, as one example. Nucleic acid amplification can involve rapidly copying millions to billions of copies of a very small nucleic acid sample, such as DNA or RNA. These techniques can include be used for sequencing genes, diagnosing viruses, identifying cancers, and others. In some nucleic acid amplification techniques, a small sample of nucleic acid is combined with reactants that can form copies of the nucleic acid. In some examples, the blister packs can be used to supply such reactants and/or buffers for reconstituting dried reactants as mentioned above.

Other fluids may also be useful in sample preparation processes. Accordingly, the blister packs described herein can include multiple reservoirs containing multiple fluids. In some examples, the blister pack can include a reservoir containing an inert mechanical fluid, which can be a gas such as air. Thus, one of the blisters in the blister pack can be a gas blister. In certain sample preparation processes, the gas blister can be actuated to force the gas through fluidic channels in the cartridge to push liquids through the channels. For example, the gas can push reconstituted PCR master mix reactants through the fluidic channels. In certain examples, the gas can be push reconstituted PCR master mix reactants through a channel leading to a biological sample so that the biological sample mixes with the PCR master mix reactants. The gas can also eject this mixture from the cartridge in some examples.

In other examples, a blister pack reservoir can include an inert mechanical fluid that is a non-Newtonian plugging fluid. The non-Newtonian plugging fluid can have the mechanical function of separating fluids one from another. Certain sample preparation devices can use a non-Newtonian plugging fluid to form a plug in a fluidic channel to partition fluids on either side of the plug. The non-Newtonian plugging fluid can keep fluids on either side of the plug separate, even against a pressure head, because the non-Newtonian plugging fluid can have a high viscosity that keeps the plug in place. In particular, the non-Newtonian plugging fluid can have a high viscosity when the fluid is at rest, after the plug has been formed. This plug of non-Newtonian fluid can act as a shutoff valve because the plug can block the fluidic channel so that fluids do not flow through the channel. Forming valves in small fluidic channels can often be difficult and expensive. The use of non-Newtonian plugging fluid can provide a simple and inexpensive solution for stopping flow through small fluidic channels. In particular, the non-Newtonian plugging fluid can separate fluids on either side of the plug. In some specific examples, a non-Newtonian plugging fluid can be used in a sample preparation device that is used to isolate a biological component from a biological sample. A particular biological component can be separated from a biological sample, and the non-Newtonian plugging fluid can be used to partition the biological component from the remainder of the biological sample. As mentioned above, the non-Newtonian plugging fluid can form a plug between the biological component and the biological sample, and this plug can remain in place because the non-Newtonian plugging fluid has a high viscosity at rest. In some examples, the biological component can be purified and/or concentrated and this purified or concentrated biological component can be partitioned from the remainder of the biological sample using the non-Newtonian plugging fluid. In more specific examples, the sample preparation device can be used in a process of preparing samples for a PCR assay. In some examples, a nucleic acid from a biological sample fluid can be concentrated and/or purified by the sample preparation device, and the non-Newtonian plugging fluid can be used to partition this concentrated or purified nucleic acid from the remainder of the biological sample fluid. Because the volumes of sample fluid and reactant involved in this process are very small, it can be beneficial to use sample preparation devices having small fluidic channels and reservoirs such as those described herein. The non-Newtonian plugging fluids described herein can provide a useful alternative to mechanical valves in such small fluidic channels.

In one example, a sample preparation device includes interconnected volumes with a bulk fluid volume fluidically connected in series with a capillary output channel to receive a density gradient column. A reservoir of a non-Newtonian plugging fluid is positioned outside the interconnected volumes. A plugging fluid injection opening is also positioned at a location along a length of the capillary output channel to inject the non-Newtonian plugging fluid into the capillary output channel. The non-Newtonian plugging fluid has a sufficiently high viscosity to partition fluid upstream of the non-Newtonian plugging fluid from fluid downstream of the non-Newtonian plugging fluid. As mentioned above, the non-Newtonian plugging fluid can have a high viscosity when at rest. In various examples, a sufficient viscosity can vary depending on the conditions of fluids in a particular fluidic channel. In certain examples, a fluid can be positioned along the density gradient column that is above (upstream) the plug of non-Newtonian plugging fluid. The fluid above the plug can exert a pressure on the plug due to the force of gravity on the fluid (i.e., the pressure head of the fluid). The non-Newtonian plugging fluid can have a sufficient viscosity to hold the plug in place, against the pressure head of the fluid above the plug. The level of viscosity that is sufficient can also be affected by the diameter of capillary output channel, since a smaller diameter capillary can allow a less viscous plugging fluid to support a given pressure head. In some examples, the capillary output channel can have a column diameter from 0.2 mm to 3 mm. Additionally, the fluid above the non-Newtonian plugging fluid can exert a pressure of up to 8 inches of water, or up to 12 inches of water, or up to 16 inches of water. In such examples, the level of viscosity that is sufficient to partition the fluid upstream of the plug from fluid downstream of the plug can be 5,000 centipoise or greater in some examples. In other examples, the sufficient viscosity can be 10,000 centipoise or greater, or 15,000 centipoise or greater, or 20,000 centipoise or greater. Viscosity is often referred to more specifically as dynamic viscosity, and can be measured using a viscometer such as viscometers available from AMETEK, Inc. (USA), Anton Paar GmbH (Austria), or IKA (Germany). Some non-Newtonian fluids can act as if they have an infinite viscosity when the amount of shear stress applied to the fluid is below a certain threshold. Thus, in some examples the non-Newtonian fluid plug can effectively have an infinite viscosity when the non-Newtonian fluid is at rest in the capillary output channel.

The term “non-Newtonian” refers to fluids that do not follow Newton's law of viscosity, which states that a fluid has a constant viscosity regardless of stress. Therefore, non-Newtonian fluids can have a viscosity that varies depending on the stress applied to the fluid. Non-Newtonian fluids can be categorized in certain categories depending on how the viscosity of the fluids changes with changes in stress. In certain examples, the non-Newtonian plugging fluid can be a Bingham plastic, a viscoplastic, a shear thinning fluid, or a curable fluid. The term “Bingham plastic” refers to fluids that behave as a rigid body at low stresses but flow as a viscous fluid having a constant viscosity at high stresses, above a yield stress threshold. The term “viscoplastic” is broader, in that a Bingham plastic is one type of viscoplastic fluid, but other types of viscoplastic fluids exist as well. Viscoplastic fluids include fluids that behave as a rigid body at low stresses but flow as a viscous fluid at high stresses. Not all viscoplastic fluids have a constant viscosity above the yield stress as Bingham plastics do. Additionally, “shear-thinning fluid” refers to fluids that have a decreasing viscosity with increasing stress. Finally, curable fluids can have a viscosity that increases upon curing. For example, a curable fluid can have a low viscosity before being cured and a higher viscosity after being cured. In some examples, a curing fluid can be injected into a channel to form a plug and then the fluid can be cured to increase the viscosity of the fluid. These fluids can be referred to as “plugging fluids” because the fluids can be used to form a plug in a channel, where the plug can prevent other fluids from flowing through the channel. Thus, the plug of non-Newtonian plugging fluid can act as a separator or shut-off valve for the channel.

In further examples, the non-Newtonian plugging fluid can include a mineral oil-based grease, a vegetable oil-based grease, a petroleum oil-based grease, a synthetic oil-based grease, a semi-synthetic oil-based grease, a silicone oil-based grease, or a combination thereof. Regarding the viscosity of greases, because of the strong shear thinning behavior of many greases, an additional measurement of the consistency can be useful besides normal dynamic viscosity. Consistency of grease can be expressed as an NLGI (National Lubricating Grease Institute) consistency number. This number can be measured using the standard classification and specification of lubricating grease, which is reproduced in ASTM D4950. The NLGI consistency number can be one of nine grades, included grade 000, grade 00, grade 0, grade 1, grade 2, grade 3, grade 4, grade 5, and grade 6. The grades progress from softer consistency to harder consistency. In some examples, the non-Newtonian plugging fluids described herein can have an NLGI consistency number from 0 to 6. In further examples, the NLGI consistency number can be from 1 to 5, from 2 to 5, from 1 to 4, or from 2 to 4. In some examples, the plugging fluid injection opening can be positioned to inject the plugging fluid into the capillary output channel. The non-Newtonian plugging fluid can have a holding pressure from 1,000 Pa to 5,000 Pa when the non-Newtonian plugging fluid is injected into the capillary output channel.

The blister packs described herein can be used in cartridge modules that include multiple interconnected volumes inside the cartridge modules. In some examples, the interconnected volumes can hold fluids in a density gradient column. In further examples, the density gradient column can include a sample fluid, where the sample fluid includes magnetizing particles having a biological component bound thereto dispersed therein. The sample fluid can be loaded into the cartridge module above a wash buffer. The wash buffer can have a higher density compared to the sample fluid, so that the sample fluid remains above the wash buffer in the density gradient column. The cartridge module can be used in a sample preparation device that can move the magnetizing particles from the sample fluid, through the wash buffer, and into a capillary output channel. Thus, the biological component that is bound to the magnetizing particles is separated from the remainder of the sample fluid. Then, using the blister pack reservoirs described above, the non-Newtonian plugging fluid can be used to partition the wash buffer and sample fluid from the concentrated magnetizing particles and biological component; reconstituted PCR master mix reagents can be mixed with the concentrated magnetizing particles and biological component; and the mixture can be ejected from the cartridge module using gas from a gas blister reservoir. Such sample preparation devices are described in more detail below. Any features of sample preparation devices described herein can also be included in blister packs, cartridge modules, methods, in various examples.

It is noted that when discussing examples of sample preparation blister packs, sample preparation cartridge modules that include blister packs, and methods described herein, such discussions can be considered applicable to one another whether or not they are explicitly discussed in the context of that example. Thus, for example, when discussing a reagent in a sample preparation blister pack, such disclosure is also relevant to and directly supported in the context of a sample preparation cartridge module or a method of making a sample preparation cartridge module, and vice versa.

Terms used herein will have the ordinary meaning in the relevant technical field unless specified otherwise. In some instances, there are terms defined more specifically throughout the specification or included at the end of the present specification, and thus, these terms can have a meaning as described herein.

### Sample Preparation Blister Packs

The present disclosure describes sample preparation blister packs that can contain fluids for facilitating isolation of a biological component from a biological sample. The blister pack can be formed of an actuatable barrier layer and a seal barrier layer. The actuatable barrier layer can be made from a flexible material such as aluminum foil. The actuatable barrier layer can include bulged portions that form blisters. The seal barrier layer can be place on the actuatable barrier layer to seal the volumes inside the blisters. In some examples, the blisters can be filled with fluids before being sealed by the seal barrier layer. Thus, the volume inside the blisters can be used as reservoirs containing the fluids.

Fluids can be ejected from the blister pack by actuating the blisters in the actuatable barrier layer and rupturing the seal barrier layer. As used herein, “actuating” can include exerting a mechanical force on the blisters of the actuatable barrier layer that tends to compress the blisters. This can be accomplished by pressing on the blisters, squeezing the blisters, rolling a roller over the blisters, or by another suitable method. In certain examples, a sample preparation device can include an actuator such as a mechanical piston that can press on the blisters. In other examples, blisters can be pressed manually by a human finger or in another way.

The example blister packs described herein can include a first reservoir containing an inert mechanical fluid (there can be one or multiple “first” reservoirs, e.g., a gas-containing reservoir, a non-Newtonian fluid-containing reservoir such as for plugging a channel, etc.). As used herein, “inert mechanical fluid” refers to a fluid that is chemically inert so that the fluid does not participate in chemical reactions with other reagents or sample materials in a sample preparation process. The fluid is a “mechanical” fluid because the fluid is used mechanically. As used here, a using a fluid mechanically specifically refers to using the fluid to move other fluids through a fluidic device, such as by applying pressure to push other fluids through channels in a fluidic device, or using the fluid to separate fluids one from another, such as by forming a plug or barrier to separate fluids. In some examples, the inert mechanical fluid can refer to either a gas or a non-Newtonian plugging fluid. Therefore, in some examples, a reservoir containing an inert mechanical fluid can be a gas reservoir containing a gas. In other examples, a reservoir containing an inert mechanical fluid can be a non-Newtonian plugging fluid reservoir containing a non-Newtonian plugging fluid. In many examples, a blister pack can include both a gas reservoir and a non-Newtonian plugging fluid reservoirs. In other examples, a blister pack can include a gas reservoir or a non-Newtonian plugging fluid, but not both.

In some examples, a gas reservoir can contain a gas such as air. The gas reservoir blister can be pressed to pressurize the gas, and the pressure of the gas can be used to push other fluids through channels in a fluidic device in some examples. Thus, the gas can be used mechanically as described above. In further examples, a non-Newtonian plugging fluid reservoir blister can be pressed to inject a non-Newtonian plugging fluid into a channel in a fluidic device. The non-Newtonian plugging fluid can be a fluid that has a sufficiently high viscosity after being injected so that the non-Newtonian plugging fluid can form a plug separating fluid on either side of the plug. This is another example of the fluid being used mechanically. Gas reservoirs and non-Newtonian plugging fluid reservoirs are described in more detail below.

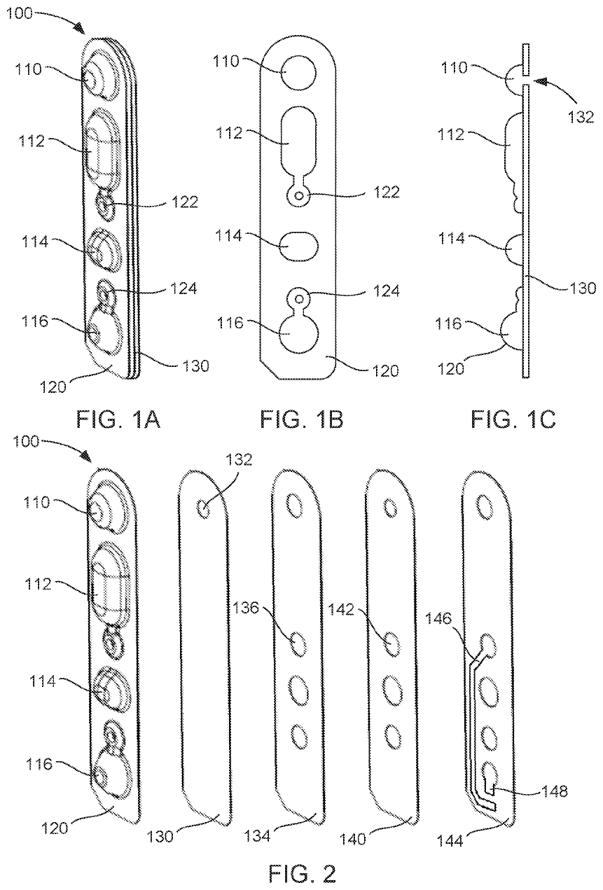

FIG. 1A shows an example sample preparation blister pack 100. This blister pack includes a plurality of reservoirs 110, 112, 114, and 116. The reservoirs are formed as blisters that include an actuatable barrier layer 120 and a seal barrier layer 130 with the contents of the reservoirs between the actuatable barrier layer and the seal barrier layer. The contents of the reservoirs can vary depending on the particular application of the blister pack. In some examples, the contents can include fluids that are used to facilitate isolation of a biological component from a biological sample. In certain examples, a first reservoir can contain an inert mechanical fluid. In a particular example, the inert mechanical fluid can be gas, a non-Newtonian fluid, or there can be multiple reservoirs or blisters that contain gases, non-Newtonian fluids, etc. In further examples, a second reservoir (or multiple “second reservoirs”) can contain a reagent, a buffer, or a combination thereof.

FIG. 1B shows a front view of the sample preparation blister pack of FIG. 1A. The shape of the blisters shown in this figure is merely one example. In other examples, the blisters of the blister pack can have any desired shape and size. In some examples, the size of individual blisters can be selected so that the blister reservoirs provide a correct volume of fluid when the actuatable layer is pressed. In various examples, the blisters can have a length or a width from 2 mm to 50 mm, or from 3 mm to 30 mm, or from 5 mm to 20 mm, or from 5 mm to 10 mm, or from 7 mm to 50 mm, or from 7 mm to 20 mm, or from 7 mm to 15 mm. In certain examples, the blisters can have a circular shape and the length and width of the blisters can be a diameter. In other examples, the blisters can have an oblong shape. The length can be measured in the same direction as the length of the blister pack as a whole, which can be the longer dimension. The width of the blister pack can be the relatively shorter dimension of the blister pack. In further examples, the individual blisters can have a volume (i.e., the volume of fluid that can be contained within the blister) from 20 μL to 500 μL, or from 30 μL to 400 μL, or from 40 μL to 300 μL, or from 40 μL to 200 μL, or from 100 μL to 200 μL, or from μL to 100 μL.

As mentioned above, in some examples the blister pack can have a relatively long length and narrower width. In some examples, the blister pack can have a width that is from 5 mm to 20 mm, or from 5 mm to 18 mm, or from 10 mm to 17 mm. In certain examples, the width of the blister pack can be about the width of the individual blisters or greater. In some examples, the width of the blister pack can be from 100% to 300% of the width of the individual blisters, or from 100% to 200% of the width of the individual blisters, or from 100% to 150% of the width of the individual blisters. In further examples, the length of the blister pack can be from 50 mm to 200 mm, or from 50 mm to 160 mm, or from 50 mm to 135 mm, or from 100 mm to 135 mm.

FIG. 1C shows a side cross-sectional view of the sample preparation blister pack 100 of FIG. 1A. This figure shows that the reservoirs 110, 112, 114, and 116 are formed as bulging blisters in the actuatable barrier layer 120. The seal barrier layer 130 is placed on the surface of the actuatable barrier layer to seal the reservoirs. This figure also shows a pre-shaped opening 132 into reservoir 110. In certain examples, this reservoir can contain a gas such as air. The pre-shaped opening can allow the gas to the ejected from the reservoir easily, without further rupturing the seal barrier layer. In some cases, contents of the reservoirs can be ejected from the blister pack by pressing on the actuatable barrier layer with sufficient pressure to burst the seal barrier layer. However, this may cause an undesired burst of pressure in the fluidic channels of the cartridge module to which the blister pack is attached. Accordingly, in some examples a pre-shaped opening can be used to allow the contents of the reservoir to be ejected from the reservoir without such a burst of pressure.

The example blister pack shown in FIGS. 1A-1C also includes “soft-opening” features 122, 124 for reservoirs 112 and 116. These soft-opening features include a relatively small compartment formed in the actuatable barrier layer with a concave feature formed in the actuatable barrier layer at the small compartment. When pressure is applied to the small compartment, the concave feature can puncture the seal barrier layer beneath the small compartment. After the seal barrier layer has been punctured under the small compartment, the actuatable barrier layer can be pressed over the larger reservoir. The reservoir can be fluidly connected to the small compartment, so that the fluid contents of the reservoir can flow through the small compartment to the puncture opening that was formed in the seal barrier layer.

In a more specific example, a sample preparation blister pack can have the structure shown in FIGS. 1A-1C, and the reservoirs can include a gas reservoir, a non-Newtonian plugging fluid reservoir, and a liquid reservoir. The gas reservoir can contain a gas as described above. The non-Newtonian plugging fluid reservoir can contain a non-Newtonian plugging fluid. The liquid reservoir can contain a liquid that may include a reagent, a buffer, or a combination of reagent and buffer. In certain examples, the gas reservoir can be reservoir 110 shown in FIGS. 1A-1C. The non-Newtonian plugging fluid reservoir can be reservoir 114. The liquid reservoir can be reservoir 112 or reservoir 116.

In another specific example, reservoir 112 shown in FIGS. 1A-1C can be a wash buffer reservoir. The wash buffer reservoir can contain a wash buffer. Reservoir 116 can be a reconstitution buffer reservoir containing a reconstitution buffer for reconstituting a lyophilized master mix reagent. In further detail regarding the buffers, in some examples the wash buffer can be an aqueous solution. For example, a wash buffer can include water, alcohol (such as ethanol), a binding agent, a salt, a surfactant, a stabilizing agent, buffering agents to maintain pH, or a combination thereof.

Biological samples that may be processed using the blister packs can include DNA, RNA, proteins, viruses, antibodies, or a variety of other biological materials. In one particular example, the sample preparation blister packs can be used in a process to detect a virus and the biological sample can include nucleic acids such as DNA or RNA extracted from the virus. The nucleic acids can be extracted by lysing viruses, which can result in a lysate solution containing the viral nucleic acids in addition to fragments of lysed viruses and other materials. In this example, magnetizing particles can be included in the lysate. The magnetizing particles can be surface activated for binding to the nucleic acids that are present in the lysate. Thus the nucleic acid molecules can bind to the surface of the magnetizing particles. Magnets can be used to move the magnetizing particles through a layer of wash buffer. Any virus fragments and other materials that may be adhering to the magnetizing particles can be washed off by the wash buffer. Thus, the wash buffer can be a liquid that can wash off these materials while also being safe for the nucleic acids or other biological samples. In some examples, the wash buffer can include ingredients such as water, salts, surfactants, buffering agents to maintain pH, and others. In certain examples, the wash buffer can include a densifier to increase the density of the wash buffer. Thus, the wash buffer can be denser than the lysate solution, allowing the lysate solution to be added as a layer on top of the wash buffer.

Turning to the reconstitution buffer, the reconstitution buffer can be used to reconstitute a dried reactant. In one example, the reactant can include PCR (polymerase chain reaction) master mix reactants. This type of reactant can be useful to mix with a sample containing nucleic acids in order to perform nucleic acid amplification or similar processes. PCR master mix reactants can include a mixture of multiple compounds that are used in a PCR assay. These compounds can include DNA polymerase, nucleoside triphosphate, deoxyribose nucleoside triphosphate, magnesium chloride, magnesium sulfate, template DNA, forward primer, reverse primer, tris hydrochloride, potassium chloride, and others. In certain examples, the reactant can be a lyophilized PCR master mix. Examples of commercially available PCR master mixes include TITANIUM TAQ ECODRY™ premix, ADVANTAGE 2 ECODRY™ premix (available from Takara Bio, Inc. Japan); Lyophilized Ready-to-Use and Load PCR Master Mix (available from Kerafast, Inc., USA); MAXIMO™ Dry-Master Mix (available from GenEon Technologies, USA), and others. In some examples, the reactant can be a dried reactant that includes all ingredients for the process other than water. In such examples, the reconstitution buffer can simply be water. In other examples, the reconstitution buffer can include additional ingredients, such as salts, surfactants, buffering agents to maintain pH, and others

In further detail regarding the non-Newtonian plugging fluid, this fluid can have a viscosity that is sufficient to separate fluids above the plug of non-Newtonian plugging fluid from fluids below the plug of non-Newtonian plugging fluid. This can include holding a pressure head of the fluids above the non-Newtonian plugging fluid when the plugging fluid is placed between interconnected volumes that are oriented vertically. In some examples, the viscosity of the non-Newtonian plugging fluid can be effectively infinite up to a threshold stress. In these examples, the non-Newtonian plugging fluid can act as a rigid body when the stress on the fluid is below the threshold. In other examples, the non-Newtonian plugging fluid can have a viscosity that is sufficient to support the fluids above the plug for an amount of time that can allow fluid below the plug to be ejected from the device without mixing the fluid above the plug. In certain examples, the non-Newtonian fluid plug can have a viscosity of greater than 5,000 centipoise, or greater than 10,000 centipoise, or greater than 15,000 centipoise, or greater than 20,000 centipoise.

In certain examples, the non-Newtonian plugging fluid can be grease-based. As used herein, “grease” can refer to a dispersion of a thickening agent in a liquid lubricant. Greases can often act as a solid when not under stress or when low stress is applied. However, greases can flow as a viscous fluid when higher stresses are applied. This can allow the grease to be injected into the interconnected volumes to form a plug, and then the plug can act as a solid when under low stress. In various examples, the non-Newtonian plugging fluid can include a mineral oil-based grease, a vegetable oil-based grease, a petroleum oil-based grease, a synthetic oil-based grease, a semi-synthetic oil-based grease, a silicone oil-based grease, or a combination thereof. Examples of greases that can be used can include greases available under the trade names ANTI-SEIZE TECHNOLOGY™ (A.S.T. Industries, Inc., USA), CITGOO (Citgo Petroleum Corporation, USA), JET-LUBE® (Whitmore Manufacturing LLC, USA), KRYTOX™ (Chemours Company, USA), MOBIL® (Exxon Mobil Corporation, USA), MYSTIK® (Mystik Lubricants, USA), SPRAYON® (Sprayon, USA), and SUPER LUBE® (Super Lube, USA).

The sample preparation blister packs can also include other layers in addition to the actuatable barrier layer and the seal barrier layer. In some examples, a label layer can be affixed on the seal barrier layer. The label layer can include individual openings at the individual reservoirs of the blister pack to admit fluids released from the individual reservoirs. The label layer can be affixed to the seal barrier layer by a variety of attachment methods. In certain examples, the label layer can be affixed to the seal barrier layer using a layer of pressure-sensitive adhesive. The pressure-sensitive adhesive layer can include openings that correspond to the openings in the label layer so that the openings are not blocked by pressure-sensitive adhesive. In further examples, a pressure-sensitive adhesive layer can be placed on the back side of the label layer, opposite from the seal barrier layer. This pressure-sensitive adhesive layer can be used to affix the blister pack onto a cartridge wall of a cartridge module. This pressure-sensitive adhesive layer can also include openings that correspond to the openings in the label layer. Additionally, the cartridge wall can include fluidic supply channels formed in the surface of the cartridge wall. In some examples, the pressure-sensitive adhesive layer can include openings that correspond to these supply channels so that the pressure-sensitive adhesive does not cover the supply channels. Thus, the label layer can form a top surface to enclose the supply channels. In some examples, the label layer can provide a sufficiently strong top surface of the supply channels so that there is no danger of overlaying layers flexing down into the internal volume of the supply channels, which could obstruct the supply channels. For example, without the label layer, the actuatable barrier layer could potentially flex into the volume of a supply channel when a blister is pressed, which could obstruct the supply channel. Therefore, the label layer can protect the supply channels from obstruction and maintain an open internal volume in the supply channels. The label layer can be made from a thin material such as a plastic film, foil, paper, or similar material.

FIG. 2 shows an exploded view of a sample preparation blister pack 100 including the multiple layers described above. This sample preparation blister pack includes an actuatable barrier layer 120 with reservoirs 110, 112, 114, and 116, a seal barrier layer 130, a first pressure-sensitive adhesive layer 134, a label layer 140, and a second pressure-sensitive adhesive layer 144. These layers can be assembled so that the openings in the pressure-sensitive adhesive layers and the label layer align with the reservoirs. Additionally, a preformed opening 132 in the seal barrier layer can be aligned with reservoir 110, which can contain a gas as described above. Additional openings 136 are formed in the first pressure-sensitive adhesive layer. The label layer includes openings 142 that align with the openings of the first pressure-sensitive adhesive layer. These openings are positioned to allow fluids to be ejected from the reservoirs through the seal barrier layer.

The second pressure-sensitive adhesive layer 144 shown in FIG. 2 also includes supply channel openings 146 and 148. When the sample preparation blister pack is affixed to a cartridge wall in a sample preparation cartridge module, the supply channel openings can align with fluidic supply channels that are formed in the cartridge wall. In this example, supply channel opening 146 leads from reservoir 112 down to near the bottom (when the blister pack is oriented vertically in use) of the blister pack. This blister pack is designed to be used with a cartridge wall that includes a supply channel leading from reservoir 112 down to an inlet channel near the bottom of the cartridge module. When reservoir 112 is pressed, fluid from the reservoir can flow through the supply channel to the inlet channel. Because the label layer 140 does not have a supply channel opening in this area, the label layer forms a top surface or wall of the fluidic supply channel. Additionally, in this example, supply channel opening 148 is located over a supply channel that connects to reservoir 116. In this example, fluid from reservoir 116 flows through a supply channel that includes a chamber for holding a dried reagent. The fluid can dissolve the dried reagent and then flow into the cartridge module through an inlet channel at the bottom (when the blister pack is oriented vertically in use) of the supply channel opening 148.

In some examples, the pressure-sensitive adhesive layers can include double-sided tape, glue, or other pressure-sensitive adhesives. As used herein “pressure-sensitive” refers to adhesives that can adhere to a surface when pressure is applied to stick the adhesive to the surface, without solvents, water, heat, activators, or other components to activate the adhesive. In some examples, pressure-sensitive adhesives can include an elastomer, such as acrylic, acrylate, rubber, silicone rubber, ethylene-vinyl acetate, or other elastomers. Pressure-sensitive adhesives can also include a tackifier, such as a rosin ester. In various examples, the pressure-sensitive adhesive layers can have a thickness from about 0.005 mm to about 1 mm, or from about 0.005 mm to about 0.5 mm, or from about 0.005 mm to about 0.1 mm.

### Sample Preparation Cartridge Modules

The present disclosure also describes sample preparation cartridge modules that can include the sample preparation blister packs described above. The cartridge modules can include a cartridge module body having a cartridge wall with a plurality of supply channels formed in the cartridge wall. The cartridge module body can also include a capillary output channel that is connected to the supply channels. As explained above, the sample preparation blister pack can be affixed to the cartridge wall and fluids from the reservoirs in the blister pack can flow into the supply channels when the reservoirs are actuated. As mentioned above, the reservoirs can include a reservoir of an inert mechanical fluid such as a gas or a non-Newtonian plugging fluid. The reservoirs can also include a liquid reservoir containing a reagent, a buffer, or a combination thereof. The reservoirs can also include multiple inert mechanical plugging fluid reservoirs and/or multiple liquid reservoirs. In some examples, the fluids can flow through the supply channels to the capillary output channel.

In some examples, the cartridge module body can also include interconnected volumes to contain a fluid column, such as a density gradient column. The interconnected volumes can include a capillary output channel and a bulk fluid volume. When in operation, the cartridge module can be oriented vertically and the bulk fluid volume can be above the capillary output channel. There may also be other volumes present above or below these portions, or which are included as part of these portions, e.g., sub-volumes. For example, the bulk fluid volume may include a mixing chamber connected to a biological sample input to contain and mix a composition including a biological sample and a particulate substrate. In this example, the mixing chamber may reside as part of the bulk fluid volume separated by a displaceable membrane, e.g., rupturable, piercable, puncturable, removable, etc., or other barrier or valve. In other examples, the mixing chamber may reside as part of the entire bulk fluid volume. The capillary output channel, on the other hand, may include a fluidic isolation chamber connected to the mixing chamber downstream of the mixing chamber to separate particulate substrate and a biological component from the biological sample. The separation may be by the introduction of a non-Newtonian plugging fluid at a location into the interconnected volumes, or in other examples, the introduction of a gas, e.g., air bubble in the capillary output channel to separate the mixing chamber from the fluidic isolation chamber, as described in greater detail hereinafter.

In some examples, the interconnected volumes carry a fluid column, such as a density gradient column. the terms “density gradient” can be used in various contexts herein but can refer to the ability of multiple fluids to remain separated in layers due to their density difference (with denser fluids being positioned vertically lower along the column). Thus, there can be multiple fluids that are phase separated, but are still in direct contact at a fluid interface, referred to herein as a “density-differential interface,” which is descriptive of the interface being present as a result of the density difference. Accordingly, a density gradient column can include multiple fluids of different density that are in contact at a density-differential interface.

In further examples, the interconnected volumes can include a capillary output channel. The capillary output channel can be a portion having a narrowed diameter in which capillary forces can be significant. In some examples, capillary force can allow a fluid having a lower density to occupy a position below a fluid having a higher density. For example, a fluid with a lower density can be present in the capillary output channel, and capillary forces can maintain the lower density fluid in the capillary output channel even when a higher density fluid is present above the capillary output channel. The terms “capillary force” or “capillary force-supported gradient” can refer to fluid interfaces that are not maintained by density difference, but rather, the fluids of immediately adjacent layers can have different densities, but less dense fluids can be positioned below denser fluids. Less dense fluids can be constrained within the capillary output channel due to the surface tension of the fluids at the fluid interface and the interaction of the fluids with walls of the capillary output channel. The interface between such fluids can be a “capillary force-supported interface.”

When describing multiple fluids herein, the fluids may be referred to as a “first,” “second,” “third,” etc., fluid so that the fluids can be described relative to one another and for clarity in describing for understanding the disclosure. However, these terms should not be considered to be limiting. Accordingly, a “first fluid” and “second fluid” and so on can be interchangeable as is convenient for describing a particular example. The terms “first,” “second,” and so on do not imply a particular order, position, or hierarchy of the fluids.

When multiple fluids of different densities are present along the density gradient column, adjacent fluids can have a density difference that is calculated as the difference between the density of the denser fluid and the density of the lighter fluid. Example density differences between fluids of the density gradient column can be from 50 mg/mL to 3 g/mL, from 100 mg/mL to 3 g/mL, from 500 mg/mL to 3 g/mL or from 1 g/mL to 3 g/mL. The “fluid density” can be measured by calibrating a scale to zero with the container thereon and then obtaining the mass of the fluid, e.g., liquid, in grams. The volume of the measure mass can then be determined using a graduated cylinder. The density is then calculated by dividing the mass by the volume to provide the fluid density (g/mL).

In further detail regarding density gradient columns, in various examples there can be any of a number of fluids in the column, e.g., two fluids, three fluids, four fluids, etc., vertically arranged. Thus, the column can also be referred to as a “multi-fluid density gradient” column. The fluids may or may not be positioned 90 degrees from horizontal relative to one another, e.g., they may or may not be stacked or layered directly on top of one another but may be in a vessel angled at less than 90 degrees from horizontal, but the interface between the fluids can be horizontal. Thus, the term “vertically layered” refers to fluids that are on top of one another relative to a force such as gravity or centripetal force in a centrifuge with a horizontal interface extending there between, even if they are not fully directly on top of one another. A multi-fluid density gradient column does not include fluid layers where an additional substance may be used to separate one fluid layer from another. In a density gradient column, there are two or more fluids that are not separate by anything at their interface other than by separation that occurs naturally by densities of the two respective fluids. Fluid layers of the multi-fluid density gradient portion can be phase separated from one another based on fluidic properties of the various fluids, including density of the respective fluids along the column. The greater or higher the density of a fluid, relative to other fluids in the column, the closer to the bottom of the column the fluid will be located as defined or established by gravity. For example, the first fluid layer can have a first density and can form a first fluid layer of the multi-fluid density gradient portion. The second fluid layer can have a second density that can be greater than a density of the first fluid layer and can form a second fluid layer of the multi-fluid density gradient portion beneath the first fluid layer. An additional fluid layer(s), e.g., third, fourth, etc., can have a third, fourth, etc., density that can be greater than a density of the previous fluid layer and can form a third, fourth, etc., fluid layer of the multi-fluid density gradient portion beneath the second fluid layer. As a note, this is not the case for the “capillary force-supported interface.” In that instance, the surface tension of the fluid relative to the size and material of the vessel provides the ability to put less dense fluids beneath fluids of greater density.

In some examples, a density of a fluid in a fluid layer can be altered using a densifier. Example densifiers can include sucrose, polysaccharides such as FICOLL™ (commercially available from Millipore Sigma (USA)), C₁₉H₂₆I₃N₃O₉ such as NYCODENZ® (commercially available from Progen Biotechnik GmbH (Germany)) or HISTODENZ™, iodixanols such as OPTIPREP™ (both commercially available from Millipore Sigma (USA)), or combinations thereof. In further detail, example additives that can be included in the fluid layers can include sucrose, C1-C4 alcohol, e.g., isopropyl alcohol, ethanol, etc., which can be included to adjust density, and/or to provide a function with respect to biological components or materials to pass through the column.

In certain examples, the sample preparation devices described herein can include interconnected volumes that include a bulk fluid volume and a capillary output channel. The bulk fluid volume can be upstream of the capillary output channel. For example, when the sample preparation device is in operation, a density gradient column included therein and can be oriented vertically and the bulk fluid volume can be above the capillary output channel. The bulk fluid volume can be wider and can have a larger cross-section than a cross-section of the capillary output channel. The bulk fluid volume can include a conical chamber, a cylindrical chamber, or a combination thereof. A cross-section of the chamber can be round, square, triangle, rectangle, or other polygonal in shape. In some examples, the bulk fluid volume can have a diameter at the widest cross-section of from 5 mm to 5 cm, 7 mm to 4 cm, 8 mm to 3 cm, or 8 mm to 2 cm. The bulk fluid volume can be where a majority of the fluid of the density gradient column resides. The bulk fluid volume can connect to the capillary output channel at a capillary junction.

The capillary output channel can have a smaller cross-section than a cross-section of the bulk fluid volume. The capillary output channel can be an elongated tubular region and can have a round, square, triangle, rectangle, or other polygonal cross-section. In some examples, the capillary output channel at the widest cross-section can have an interior opening diameter of from 0.1 mm to 4 mm, 0.2 mm to 3 mm, 0.5 mm to 4 mm, or 1 mm to 3 mm. The capillary output channel may be tapered. For example, the capillary can be tapered and can have an interior channel diameter of 4 mm at one end to an interior channel diameter at the opposite end of 1 mm. For example, the capillary can be tapered from an interior channel diameter of 3 mm at one end to an interior channel diameter at the opposite end of 1 mm, or from 2 mm at one end to an interior channel diameter at the opposite end of 1.5 mm, or from 2 mm at one end to an interior channel diameter at the opposite end of 1 mm.

The interconnected volumes can be formed in a cartridge module body. In some examples, the cartridge module body can be made of various polymers (e.g. Polypropylene, TYGON, PTFE, COC, others), glass (e.g. borosilicate), metal (e.g. stainless steel), or a combination of materials. Additionally, the capillary output channel can also be formed in the same cartridge module body, or the capillary output channel can be made from a different material. In some examples, the capillary output channel can be formed from materials used in various microfluidic devices, such as silicon, glass, SU-8, PDMS, a glass slide, a molded fluidic channel(s), 3-D printed material, and/or cut/etched or otherwise formed features. The cartridge module body, or vessel, can be monolithic or may be a combination of components fitted together, thus indicating that interconnected volumes may be defined by a unitary device with multiple regions or may be defined by a modular device where vessel components are joined together to form the interconnected volumes.

The interconnected volumes can be operable to receive fluids, such as a sample fluid, a lysis buffer, a wash buffer, a gas, a reconstituted reagent, and the like. Fluids can be arranged along the density gradient column in layers and individual layers can be phase separated from one another at fluid interfaces. In some examples, the phase separation can be based on fluidic properties of the various fluids, including density of the respective fluids along the column. Fluid layers can be in fluid communication with adjoining fluid layers.

In the bulk fluid volume, the greater or higher the density of a fluid, relative to other fluids in the column, the closer to the bottom of the bulk fluid volume the fluid will be located. For example, when arranged vertically, a first fluid layer having a first density can form the first layer of the density gradient column. The second fluid layer having a second density greater than a density of the first fluid layer can form a second fluid layer of the density gradient column. The third fluid layer having a third density greater than a density of the second fluid layer can form a third fluid layer of the density gradient column and the like. In one example, the density gradient column can include a sample fluid positioned on top of a wash buffer, wherein the wash buffer has a greater density than the sample fluid.

In the capillary output channel, a surface tension of the fluid relative to the size and material of the vessel can provide the ability to position less dense fluids beneath fluids of greater density. In some examples, a separation gas bubble can be formed in the capillary output channel where a fluid of the density gradient column resides. The separation gas bubble can become trapped in the capillary output channel due to the surface tension in the capillary output channel. A fluid having a density that is less than the density of fluids above the separation gas bubble can be located below the separation gas bubble. For example, the fluid that is above the gas bubble can include densifiers, as described above, and the fluid below the gas bubble can be free of densifiers so that the fluid above the gas bubble has a higher density. In various examples, the density difference between the fluid above the gas bubble and the fluid below the gas bubble can be from 50 mg/mL to 3 g/mL, from 100 mg/mL to 3 g/mL, from 500 mg/mL to 3 g/mL or from 1 g/mL to 3 g/mL. The separation gas bubble can prevent intermixing despite the density difference.

Although separation gas bubbles formed in the capillary output channel can separate fluid along the density gradient column (separate two fluids, or bifurcate a single fluid along the fluid column), in some examples this separation can be difficult to maintain because the gas bubbles can be fragile and may easily be lost because the gas bubble can quickly float up through fluid in the bulk fluid volume above. In a particular example, the sample preparation device can mix a biological sample with reagents. In this particular example, the fluid in the capillary output channel can include the biological sample and reagents, and the fluid in the bulk fluid volume can include a wash buffer. The wash buffer may be separated from the sample and reagents by a gas bubble, such as an air bubble. This particular device can also include a cap covering the bottom end of the capillary output channel. The cap can be unsealed and the sample and reagents can be ejected out the bottom of the capillary output channel. However, the uncapping and ejecting process can generate back pressure in the capillary output channel, which can often push the gas bubble out of the capillary output channel, which can break the separation between the wash buffer and the sample/reagent mixture. Because the sample and reagent mixture can be less dense than the wash buffer, this can result in the sample and reagent mixture quickly rising up into the bulk fluid volume of the column, which can ruin the preparation of the sample. In certain examples, a more robust separation between the fluids can be implemented using a non-Newtonian plugging fluid. The non-Newtonian plugging fluid can be a fluid that can be injected into the capillary output channel, which can have a sufficient high viscosity to partition fluids above the non-Newtonian plugging fluid from fluids below the non-Newtonian plugging fluid. In certain examples, a combination of a gas bubble and a plug of non-Newtonian plugging fluid can be used to separate the fluid in the bulk fluid volume from fluid in the capillary output channel.

The viscosity of the non-Newtonian plugging fluid can be sufficient to separate fluids above the plug of non-Newtonian plugging fluid from fluids below the plug of non-Newtonian plugging fluid. This can include holding a pressure head of the fluids above the non-Newtonian fluid when the interconnected volumes are oriented vertically. In some examples, the viscosity of the non-Newtonian plugging fluid can be effectively infinite up to a threshold stress. In these examples, the non-Newtonian plugging fluid can act as a rigid body when the stress on the fluid is below the threshold. In other examples, the non-Newtonian plugging fluid can have a viscosity that is sufficient to support the fluids above the plug for an amount of time that can allow fluid below the plug to be ejected from the device without mixing the fluid above the plug. In certain examples, the non-Newtonian fluid plug can have a viscosity of greater than 5,000 centipoise, or greater than 10,000 centipoise, or greater than 15,000 centipoise, or greater than 20,000 centipoise.

In certain examples, the non-Newtonian plugging fluid can be grease-based. As used herein, “grease” can refer to a dispersion of a thickening agent in a liquid lubricant. Greases can often act as a solid when not under stress or when low stress is applied. However, greases can flow as a viscous fluid when higher stresses are applied. This can allow the grease to be injected into the interconnected volumes to form a plug, and then the plug can act as a solid when under low stress. In various examples, the non-Newtonian plugging fluid can include a mineral oil-based grease, a vegetable oil-based grease, a petroleum oil-based grease, a synthetic oil-based grease, a semi-synthetic oil-based grease, a silicone oil-based grease, or a combination thereof. Examples of greases that can be used can include greases available under the trade names ANTI-SEIZE TECHNOLOGY™ (A.S.T. Industries, Inc., USA), CITGOO (Citgo Petroleum Corporation, USA), JET-LUBE® (Whitmore Manufacturing LLC, USA), KRYTOX™ (Chemours Company, USA), MOBIL® (Exxon Mobil Corporation, USA), MYSTIK® (Mystik Lubricants, USA), SPRAYON® (Sprayon, USA), and SUPER LUBE® (Super Lube, USA).

In some examples, a non-Newtonian plugging fluid can be injected into the capillary output channel from a reservoir. As explained above, the reservoir can be formed as a blister in a blister pack. The blister pack can be affixed to a cartridge wall of the cartridge module body. A non-Newtonian plugging fluid supply channel can be formed in the cartridge module body and this supply channel can be aligned with the reservoir of non-Newtonian plugging fluid. The non-Newtonian plugging fluid can be injected into the capillary output channel through the supply channel.

In some examples the cartridge module body can include a sharp point located near the sealing layer of the blister pack so that the sharp point can puncture the sealing layer when pressure is applied to the blister. In other examples, the blister pack can be designed to release fluid from the blister in other ways. In one example, the sealing layer can be easy to rupture so that the sealing layer can rupture without a sharp point to puncture the sealing layer. In another example, a sharp point can be formed inside the blister, such as on the exterior flexible wall of the blister, so that the sharp point can puncture the sealing layer from the inside of the blister when pressure is applied to the blister. As mentioned above, the blister pack can include soft-opening features that allow the blisters to be opened without creating a burst of pressure in the supply channels. The soft-opening feature can include a convex portion of the actuatable barrier layer that can rupture the sealing barrier layer when actuated. Regarding the non-Newtonian plugging fluid in particular, in some examples the reservoir of non-Newtonian plugging fluid does not include a soft-opening feature. This may be because the non-Newtonian plugging fluid has a relatively high viscosity and does not cause the pressure bursts that may be caused by less viscous fluids. In certain examples, the cartridge wall can include a sharp point formed at the reservoir of non-Newtonian plugging fluid, so that the sharp point can puncture the sealing barrier layer when the blister of non-Newtonian plugging fluid is actuated.

Reservoirs can be sized and shaped to contain a fluid, a reagent, or a combination thereof. Types of reservoirs can include the buffer reservoir, inert mechanical fluid reservoirs including a non-Newtonian plugging fluid reservoir and a gas reservoir, a wash buffer reservoir, a dry reagent reservoir, or a combination thereof. The buffer reservoir can be sized to hold an appropriate volume of buffer fluid.

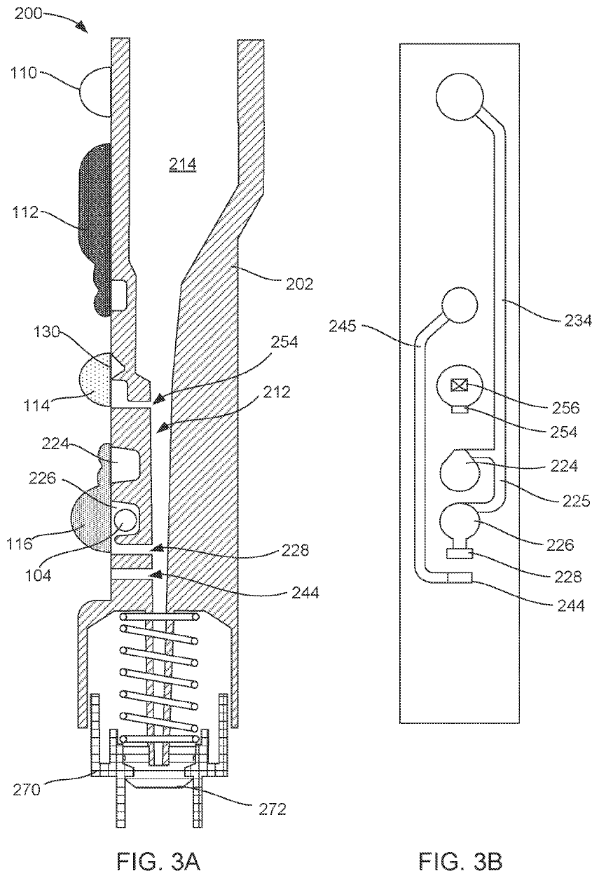

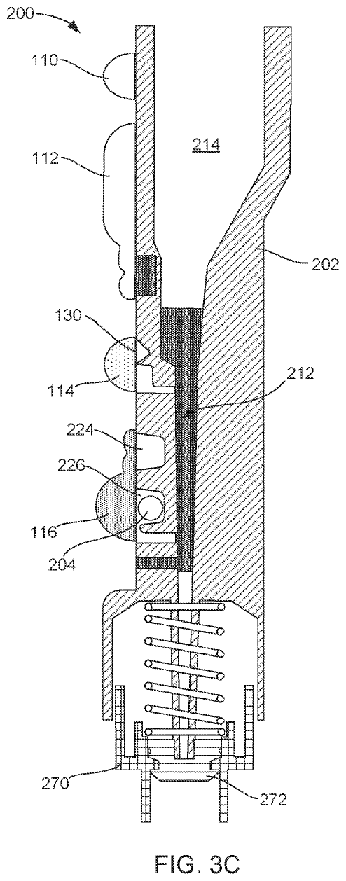

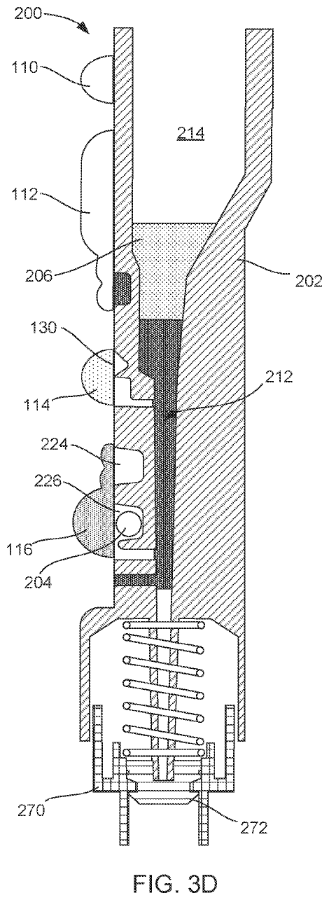

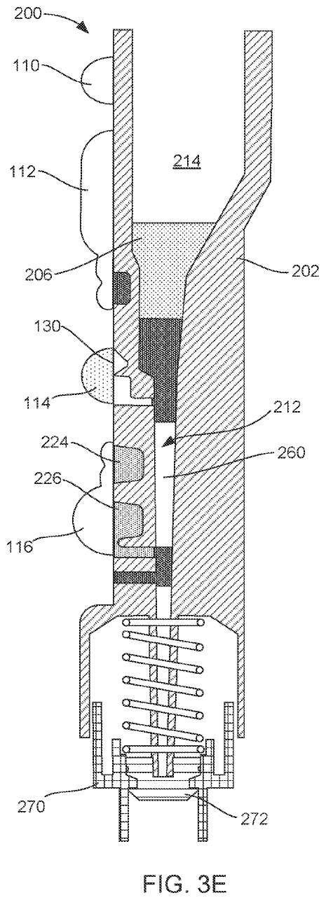

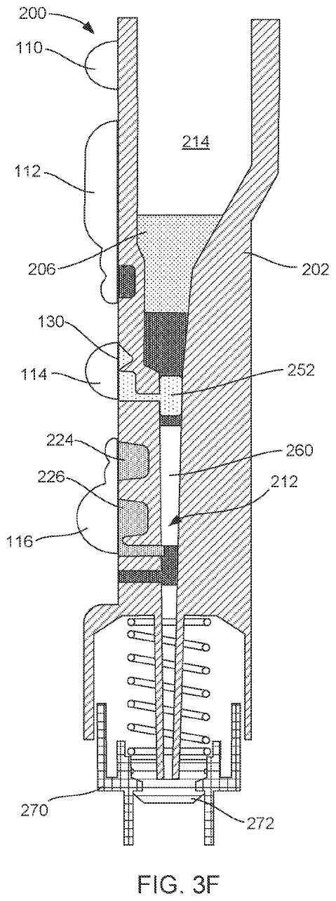

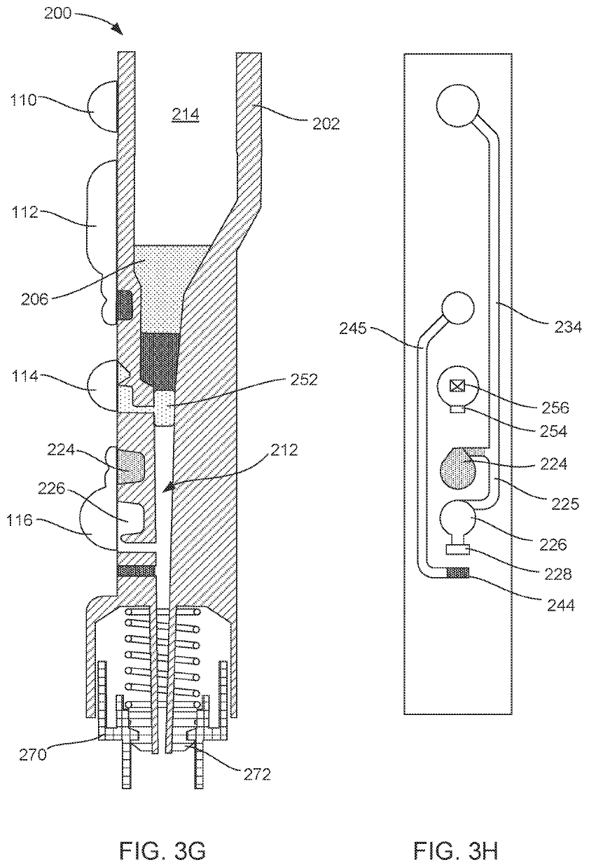

A specific example sample preparation cartridge module can be used to prepare samples for a nucleic acid amplification process such as a PCR assay. In this particular example, the samples can include nucleic acids such as DNA or RNA and the sample preparation device can mix the nucleic acids with reactants such as PCR master mix reactants. An example of this process is depicted in FIGS. 3A-3H. FIG. 3A shows a cross-sectional view of an example sample preparation cartridge module 200. The cartridge module includes a cartridge module body 202. Interconnected volumes are formed in the cartridge module body. In this example, the interconnected volumes can contain a density gradient column. The upper portion of the interconnected volumes in this example is a bulk fluid volume 214, and the lower part is a capillary output channel 212. The capillary output channel includes the narrower section at the bottom of the column, where capillary forces become more significant. The cartridge module also includes a sample preparation blister pack 100 affixed to a cartridge wall of the cartridge module body. The blister pack includes an inert mechanical fluid reservoir that in this case is a gas reservoir 110 containing air for example, a wash buffer reservoir 112, an additional inert mechanical fluid reservoir that is a non-Newtonian plugging fluid reservoir 114, and a reconstitution buffer reservoir 116. The wash buffer can be injected from the wash buffer reservoir into the capillary output channel through a first fluid injection opening 244. The non-Newtonian plugging fluid can be injected into the capillary output channel through a plugging fluid injection opening 254. The reconstitution buffer reservoir contains a reconstitution buffer. The reconstitution buffer reservoir is connected to a reconstitution buffer inlet chamber 224, which is connected to a reactant chamber 226, which is in turn connected to a reactant injection channel 228. A dried reactant 204 is held inside the reactant chamber. The reservoirs of the various fluids are kept sealed with a seal barrier layer 130. When pressure is applied to the reservoir blisters, the seal barrier layer can rupture to allow the fluids to flow into the interconnected volumes. This particular cartridge module also includes a spring loaded cap 270 that holds a flexible septum 272. The flexible septum can seal the bottom opening of the capillary output channel. If it is desired to eject fluid out of the bottom of the capillary output channel, then the spring loaded cap can be pushed upward and the bottom end of the capillary output channel can push through the septum so that the capillary output channel is unsealed and fluid can eject out the bottom opening.

To further describe the fluid channels and chambers depicted in the side, cross-sectional view of FIG. 3A, a front view is shown in FIG. 3B. This view shows the surface of the cartridge wall where the blister pack is affixed. The blister pack is not shown in FIG. 3B, so that the various chambers and fluid supply channels are visible. These chambers and fluid supply channels can be formed as recessed areas in the surface of the cartridge module body. The blister pack can be placed over this surface to enclose these chambers and fluid channels. As shown in this view, a wash buffer channel 245 is formed so that the wash buffer can flow from the wash buffer reservoir down to the first fluid injection opening 244, which is the lowest of the fluid injection openings in this example. The plugging fluid injection opening 254 is adjacent to a sharp point 256 formed on the cartridge module body. The sharp point can puncture the seal barrier layer to allow non-Newtonian plugging fluid to flow into the capillary output channel through the plugging fluid injection opening. When the reconstitution buffer reservoir ruptures, the reconstitution buffer can flow into the reconstitution buffer inlet chamber 224. Then, the reconstitution buffer can flow to the reactant chamber 226 through a reconstitution buffer channel 225. In some examples, the volume of reconstitution buffer in the reconstitution buffer reservoir can be such that squeezing the blister reservoir will cause reconstitution buffer to fill the reconstitution buffer inlet chamber and the reactant chamber, but little or no reconstitution buffer will flow into the capillary output channel at this time. The reconstitution buffer that is in the reactant chamber can then be pushed into the capillary output channel by injecting gas through a gas channel 234.

FIG. 3A and FIG. 3B show the cartridge module before beginning the example process. The process can begin as shown in FIG. 3C, by pressing on the wash buffer reservoir blister 112 to inject wash buffer into the interconnected volumes in the cartridge module. The wash buffer is injected in a lower part of the capillary output channel 212. From there, the wash buffer fills up the capillary output channel and then partially fills the bulk fluid volume 214.

FIG. 3D shows that after introducing the wash buffer into the interconnected volumes, a sample fluid 206 is loaded into the interconnected volumes from the top, above the wash buffer. The sample fluid can have a lower density than the wash buffer, so that the sample fluid remains in a layer on top of the wash buffer. Thus, the fluids form a density gradient as explained above. The sample fluid can include a biological component such as nucleic acids (e.g., DNA, RNA), or others. Other materials can also be present, such as lysate and components of lysed cells or viruses. In certain examples, the preparation of the sample fluid can include lysing viruses or cells to extract nucleic acids such as DNA or RNA therefrom. Additionally, the sample fluid in this particular example can include magnetizing particles. The magnetizing particles can be configured to bind or adhere to the biological component. Thus, magnetizing particles having biological components bound thereto can be dispersed in the sample fluid. Although not shown in the figure, the sample preparation device in this example can include a magnet or system of magnets that can be used to move the magnetizing particles downward through the interconnected volumes. Accordingly, the magnet or magnets can be used to draw the magnetizing particles across the interface from the sample fluid into the wash buffer. Then, the magnets can continue to draw the magnetizing particles down through the capillary output channel until the magnetizing particles are concentrated at the bottom of the capillary output channel. The biological component can remain bound to the magnetizing particles.

In FIG. 3E, the reconstitution buffer reservoir 116 is pressed. This causes the reconstitution buffer to flow into the reconstitution buffer inlet chamber 224 and the reactant chamber 226. The dried reactant that was held in the reactant chamber is dissolved by the reconstitution buffer. In this example, the dried reactant can include PCR master mix reactants. As the reconstitution buffer flows into the reconstitution buffer inlet chamber and the reactant chamber, the gas that was present in these chambers is displaced into the capillary output channel 212. This forms a gas gap 260. A small amount of the wash buffer remains at the bottom of the capillary output channel. This is because the wash buffer was injected through the first fluid inlet opening, which is located below the second fluid inlet opening. The gas flows in through the second fluid inlet opening to form the gas gap. As explained above, magnetizing particles with biological components bound thereon are concentrated in the wash buffer at the bottom of the capillary output channel. Therefore, the biological components remain in the small volume of wash buffer at the bottom of the capillary output channel, below the gas gap.

In FIG. 3F, the inert mechanical fluid reservoir that contains the non-Newtonian plugging fluid 114 is pressed so that the non-Newtonian plugging fluid is injected into the capillary output channel 212 of the interconnected volumes. This forms a plug 252 of non-Newtonian plugging fluid that partitions the wash buffer that is above the plug from the gas that is below the plug. As explained above, the non-Newtonian fluid can have a sufficient viscosity, after being injected into the capillary output channel, that the non-Newtonian fluid can prevent the fluid above the plug from flowing down into the capillary output channel below the plug. This figure shows the non-Newtonian plugging fluid being injected into a region of the capillary output channel that contains wash buffer, so that a small amount of wash buffer is beneath the plug between the plug and the gas gap 260. However, in other examples, the non-Newtonian plugging fluid may be injected directly into the gas gap. The plug can be in direct contact with gas, e.g., air, on the bottom of the plug and with wash buffer on the top of the plug. In still other examples, a small amount of gas from the gas gap can remain on the top of the plug. These results can depend on the size of the gas gap and the placement of the plugging fluid injection opening.

FIG. 3G shows that after the plug of non-Newtonian plugging fluid 252 has been formed, the reconstitution buffer and the small volume of wash buffer at the bottom of the capillary output channel can be ejected from the interconnected volumes. This can be accomplished by uncapping the bottom end of the capillary output channel. The spring loaded cap 270 can be pushed upward and the bottom end of the capillary output channel can penetrate through the flexible septum 272. Then, the inert mechanical fluid reservoir 110 containing the gas, such air, can be pressed to use the gas to force the reconstitution buffer and the wash buffer out of the bottom opening of the capillary output channel. To clarify how the gas flows from the gas reservoir, FIG. 3H shows a front view of the surface of the cartridge wall. The gas flows from the gas reservoir, through a gas channel 234 that connects to the fluid channel 225 between the reconstitution buffer inlet chamber and the reactant chamber. Before pressing the gas reservoir, the reactant chamber and the fluid channel were filled with the reconstitution buffer and the dissolved reactants. When the gas reservoir is pressed, the gas forces the reconstitution buffer and dissolved reactants out into the capillary output channel, and then out of the bottom opening of the capillary output channel. As shown in FIG. 3H, some of the reconstitution buffer remains in the reconstitution buffer inlet chamber, as this chamber is bypassed by the gas, e.g., air, from the gas reservoir.

The process shown in FIGS. 3A-3H can be used to prepare mixtures of biological components with reactants such as PCR master mix reactants. This mixture can then be further analyzed and processed using appropriate equipment. After the mixture of biological components and PCR master mix reactants is ejected from the bottom of the capillary output channel as shown in FIG. 3G, the capillary output channel can be re-capped and the cartridge module can be discarded.

Although a specific example process has been shown and described in detail, the sample preparation devices according to the present disclosure can be used to perform a variety of other processes, and the sample preparation devices can include other components besides those described above. In some examples, various fluids can be added to a density gradient column in the sample preparation device. In one example, the density gradient column can include a sample fluid and a wash buffer. In another example, the density gradient column can include a sample fluid, a wash buffer, a gas, and a reconstituted reagent. In yet another example, the density gradient column can include a sample fluid, a lysis buffer, a wash buffer, a gas, and a reconstituted reagent.

The fluid layers of the density gradient column can be formulated to interact with the magnetizing particles that can be present in the sample fluid. The sample fluid layer and other individual fluid layers can have different functions. For example, a fluid layer can include a lysis buffer to lyse cells. In yet other examples, a fluid layer can be a surface binding fluid layer to bind the biological component to the magnetizing particles, a wash fluid layer can trap contaminant from a sample fluid and/or remove contaminant from an exterior surface of the magnetizing particles, a surfactant fluid layer can coat the magnetizing particles, an elution fluid layer can remove the biological component from the magnetizing particles following extraction from the biological sample, a labeling fluid layer can bind labels to the biological component such as a fluorescent label (either attached to the magnetizing particles or unbound thereto), and so on.

In some examples, individual fluid layers can provide sequential processing of a biological sample. For example, individual fluid layers can carry out individual functions, and in many cases, the functions can be coordinated to achieve a specific result. For example, in isolating a biological component found in a cell of a biological sample, sequential fluid layers from top to bottom of a density gradient column can act on the biological sample to lyse cells in a fluid layer, bind a biological component from the lysed biological material to magnetizing particles, wash the magnetizing particles with the biological material bound thereto in a fluid layer, combine biological material with a reagent, and/or elute (or separate) the biological material from the magnetizing particles.

A vertical height of individual fluid layers of the density gradient column can vary. Adjusting a vertical height of an individual fluid layer can affect a residence time of the paramagnetic particles in that fluid layer. The taller the fluid layer, the longer the residence time of the magnetizing particles in the fluid layer. In some examples, all of the fluid layers of the density gradient column can be the same vertical height. In other examples, a vertical height of individual fluid layers in a multi-fluid density gradient column can vary from one fluid layer to the next. In one example, a vertical height of the individual fluid layers can individually range from 10 μm to 50 mm. In another example, a vertical height of the individual fluid layers can individually range from 10 μm to 30 mm, from 25 μm to 1 mm, from 200 μm to 800 μm, or from 1 mm to 50 mm.

The cartridge module body that defines the interconnected volumes may further include openings, inputs, outputs, and/or ports. For example, the cartridge module body may include an opening, an input, and/or a port to permit loading of fluids and reagents into the interconnected volumes. For example, a fluid injection opening can permit loading of a sample fluid, a wash buffer, and the like into the bulk fluid volume of the interconnected volumes. In yet other examples, the interconnected volumes can include an input or port to permit loading of fluids and reagents to form the density gradient column. The interconnected volumes may also include outputs. For example, the capillary output channel may include a fluidic output that can permit dispensing of a biological component, a biological sample, a fluid, magnetizing particles, or a combination thereof, from the density gradient column. In yet other examples, the cartridge module body defining the interconnected volumes may include an output for venting gas to relieve pressure along the interconnected volumes.

Reservoirs may be arranged to allow a fluid or a reagent therein to be individually dispensed into the density gradient column and/or arranged in series to allow a fluid, a reagent, or a combination thereof to be dispensed sequentially or at the same time into the density gradient column.

The magnetizing particles, in further detail, can be in the form of paramagnetic microparticles, superparamagnetic microparticles, diamagnetic microparticles, or a combination thereof, for example. The term “magnetizing particles” is defined herein to include particles or microparticles, e.g., magnetizing microparticles, that may not be magnetic in nature unless and until a magnetic field is introduced at a strength and proximity to cause them to become magnetic. Their magnetic strength can be dependent on the magnetic field applied and may get stronger as the magnetic field is increased, or the magnetizing particles get closer to a magnet applying the magnetic field.

In more specific detail, “paramagnetic microparticles” have these properties, in that they have the ability to increase in magnetism when a magnetic field is present; however, paramagnetic microparticles are not magnetic when a magnetic field is not present. In some examples, the paramagnetic microparticles can exhibit no residual magnetism once the magnetic field is removed. A strength of magnetism of the paramagnetic microparticles can depend on the strength of the magnetic field, the distance between a source of the magnetic field and the paramagnetic microparticles, and a size of the paramagnetic microparticles. As a strength of the magnetic field increases and/or a size of the paramagnetic microparticles increases, the strength of the magnetism of the paramagnetic microparticles increases. As a distance between a source of the magnetic field and the paramagnetic microparticles increases, the strength of the magnetism of the paramagnetic microparticles decreases. “Superparamagnetic microparticles” can act similar to paramagnetic microparticles; however, they can exhibit magnetic susceptibility to a greater extent than paramagnetic microparticles in that the time it takes for them to become magnetized appears to be near zero seconds. “Diamagnetic microparticles,” on the other hand, can display magnetism due to a change in the orbital motion of electrons in the presence of a magnetic field.

The magnetizing particles can be surface-activated to selectively bind with a biological component or can be bound to a biological component from a biological sample. An exterior of the magnetizing particles can be surface-activated with interactive surface groups that can interact with a biological component of a biological sample or may include a covalently attached ligand. In some examples, the ligand can include proteins, antibodies, antigens, nucleic acid primers, nucleic acid probes, amino groups, carboxyl groups, epoxy groups, tosyl groups, sulphydryl groups, or the like. In one example, the ligand can be a nucleic acid probe. The ligand can be selected to correspond with and to bind with the biological component. The ligand may vary based on the type of biological component targeted for isolation from the biological sample. For example, the ligand can include a nucleic acid probe when isolating a biological component that includes a nucleic acid sequence. In another example, the ligand can include an antibody when isolating a biological component that includes antigen. In one example, the magnetizing particles can be surface-activated to bind to nucleic acid such as DNA or RNA. Thus DNA or RNA molecules can be bound to the surface of the magnetizing particles. Commercially available examples of magnetizing particles that are surface-activated include those sold under the trade name DYNABEADS®, available from ThermoFischer Scientific (USA).

In some examples, the magnetizing particles can have an average particle size that can range from 10 nm to 50,000 nm. In yet other examples, the magnetizing particles can have an average particle size that can range from 500 nm to 25,000 nm, from 10 nm to 1,000 nm, from 25,000 nm to 50,000 nm, or from nm to 5,000 nm. The term “average particle size” describes a diameter or average diameter, which may vary, depending upon the morphology of the individual particle. A shape of the magnetizing particles can be spherical, irregular spherical, rounded, semi-rounded, discoidal, angular, sub-angular, cubic, cylindrical, or any combination thereof. In one example, the particles can include spherical particles, irregular spherical particles, or rounded particles. The shape of the magnetizing particles can be spherical and uniform, which can be defined herein as spherical or near-spherical, e.g., having a sphericity of >0.84. Thus, any individual particles having a sphericity of <0.84 are considered non-spherical (irregularly shaped). The particle size of the substantially spherical particle may be provided by its diameter, and the particle size of a non-spherical particle may be provided by its average diameter (e.g., the average of multiple dimensions across the particle) or by an effective diameter, e.g., the diameter of a sphere with the same mass and density as the non-spherical particle.

In an example, the magnetizing particles can be unbound to a biological component when added to the density gradient column. Binding between the magnetizing particles and the biological component of the biological sample can occur within the interconnected volumes. In yet another example, the magnetizing particles and a biological sample including a biological component can be combined before the sample fluid is added to the interconnected volumes.

In some examples, the sample preparation device can also include a magnet capable of generating a magnetic field. The magnetic field may be turned on and off by introducing electrical current/voltage to the magnet. The magnet can be permanently placed, can be movable along the interconnected volumes, or can be movable in position and/or out of position to effect movement of the magnetizing particles in and through the interconnected volumes. Thus, magnetizing particles can moved through a fluid column, such as a density gradient column, by magnetic manipulation by the magnet.

The magnetizing particles can be magnetized by the magnetic field generated by the magnet. The magnet can also create a force capable of pulling the magnetizing particles through the density gradient column, holding the magnetizing particles at a location along the density gradient column, or a combination thereof. When the magnet is turned off or not in appropriate proximity, the magnetizing particles can reside in a fluid layer until gravity pulls the magnetizing particles through fluid layers of the density gradient column, or they may remain suspended in the fluid layer in which they may reside until the magnetic field is applied thereto. The rate at which gravity pulls the magnetizing particles through fluid layers (or leaves the magnetizing particles within a fluid layer) can be based on a mass of the magnetizing particles, a quantity of the magnetizing particles, and a surface tension at the fluid interface between fluid layers. The magnet can cause the magnetizing particles to move from one fluid layer to another or can increase a rate at which the magnetizing particles pass from one fluid layer into another.

Strength of the magnetic field and the location of the magnet in relation to the magnetizing particles can also affect a rate at which the magnetizing particles move through the density gradient column carried within the interconnected volumes. The further away the magnet and the lower the strength of the magnetic field, the slower the magnetizing particles will move.

In an example, the magnet can be moveable in position, out of position, or at variable positions to effect downward movement, rate of movement, or to promote little to no movement of the magnetizing particles. In another example, the magnet can be positioned adjacent to a side of the multi-fluid density gradient column and can move vertically to cause the magnetizing particles to move therewith. In some examples, the magnet can be a ring magnet that can be placed around a circumference of the interconnected volumes to move the magnetizing particles through the density gradient column. In some examples, a movable magnet(s) can be positioned adjacent to a side of the interconnected volumes that contain the density gradient column, and the magnet(s) in this example are not a ring shape, but rather can be any shape effective for moving magnetizing particles along the density gradient column. In some examples, the magnet can be moved along a side and/or along a bottom of the multi-fluid density gradient column to pull the magnetizing particles in one direction or another. In one example, the magnet can be used to pull the magnetizing particles downwardly through fluid layers of the density gradient column.

In yet other examples, a magnet can be used to concentrate and hold the magnetizing particles near a side wall of the cartridge module body, e.g., vessel, defining the interconnected volumes. For example, the magnet can concentrate the magnetizing particles near a side wall of the cartridge module body and heat can be applied to decouple and separate an isolated biological component from the magnetizing particles. The magnet can continue to hold the magnetizing particles while an outlet of the interconnected volumes can be opened thereby allowing dispensing of the isolated biological component from the density gradient column where the biological component is separated from the magnetizing particles.

In some examples, the magnets described above can be a part of the cartridge module. In other examples, the magnet can be part of a device or system that the cartridge module can be loaded into. In some cases, the cartridge module can be disposable after use. Thus, magnets, actuators, and other more expensive and re-usable devices can be parts of a re-usable system that the disposable cartridge module can be loaded into. In certain examples, multiple cartridge modules can be included in a full cartridge. A cartridge can include, for example, 2 cartridge modules, 4 cartridge modules, 8 cartridge modules, 10 cartridge modules, 16 cartridge modules, or any other number of cartridge modules. Similarly, blister packs can be prepared for use with cartridges having multiple cartridge modules. For example, a cartridge having 8 cartridge modules can include a blister pack that has 8 sets of reservoirs. In some examples, such a blister pack having multiple sets of reservoirs can be manufactured as a single blister pack that can be affixed to the cartridge.

### Methods of Making Sample Preparation Cartridge Modules

The present disclosure also describes methods of making sample preparation cartridge modules. These methods can include affixing a blister pack as described above onto a cartridge wall of a cartridge module body as described above. In some cases, the blister pack can be manufactured separately from the cartridge module body. Therefore, to form a complete cartridge module, the blister pack can be affixed to the cartridge module body.

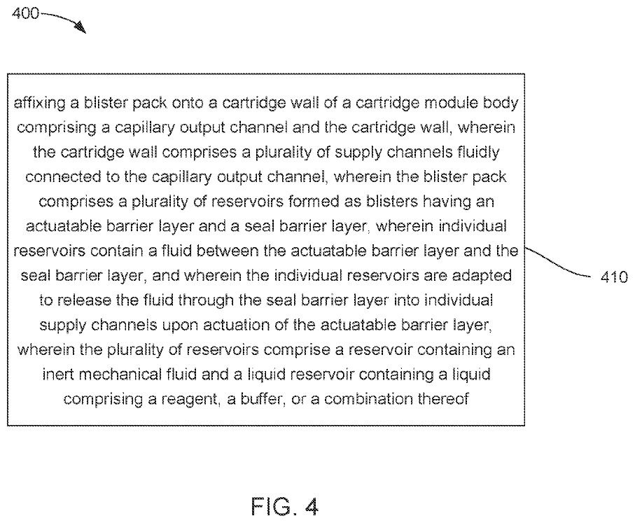

In a specific example, a method 400 of making a sample preparation cartridge module is shown at FIG. 4, and can include affixing 410 a blister pack onto a cartridge wall of a cartridge module body. The cartridge module body can include a capillary output channel and the cartridge wall. The cartridge wall can include a plurality of supply channels fluidly connected to the capillary output channel. The blister pack can include a plurality of reservoirs formed as blisters having an actuatable barrier layer and a seal barrier layer. The individual reservoirs can contain a fluid between the actuatable barrier layer and the seal barrier layer. The reservoirs can be adapted to release the fluid through the seal barrier layer into individual supply channels upon actuation of the actuatable barrier layer. The plurality of reservoirs can include: a gas reservoir containing a gas; a non-Newtonian plugging fluid reservoir containing a non-Newtonian plugging fluid; and a liquid reservoir containing a liquid that includes a reagent, a buffer, or a combination thereof.

In further examples, the blister pack can include a label layer affixed on the seal barrier layer, as described above. The label layer can include individual openings at the individual reservoirs to admit fluids released from the individual reservoirs. Additionally, the blister pack can be affixed onto the cartridge wall using a pressure-sensitive adhesive layer that also includes individual openings aligned with the individual openings of the label layer. The pressure sensitive adhesive layer can also include a supply channel opening, or multiple supply channel openings, aligned with a supply channel of the cartridge wall. In some examples, the pressure-sensitive adhesive layer can be included on the blister pack, so that the blister is “self-stick,” allowing the blister pack to be easily affixed to the cartridge module without additional components.

Additionally, as explained above, in some examples a blister pack can include multiple sets of reservoirs and the blister pack can be affixed to a cartridge that is made of multiple cartridge modules. In one example, the blister pack can include 8 sets of reservoirs. The individual sets of reservoirs can include multiple reservoirs lined up vertically (when the blister pack is oriented vertically for use). The sets of reservoirs can align with individual cartridge modules when the blister pack is affixed to the cartridge modules. In this example, the cartridge can include 8 cartridge modules to match the 8 sets of reservoirs. In other examples, any other number of cartridge modules can be used, with a corresponding number of sets of reservoirs in the blister pack.

### Definitions

It is noted that, as used in this specification and the appended claims, the singular forms “a,” “an,” and “the” include plural referents unless the context clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and determined based on experience and the associated description herein.

As used herein, the term “interact” or “interaction” as it relates to a surface of the particulate substrates, such as the magnetizing particles, indicates that a chemical, physical, or electrical interaction occurs where a particulate substrate surface property is modified in some manner that is different than may have been present prior to entering the fluid layer, but does not include modification of magnetic properties magnetizing particles as they are influenced by the magnetic field introduced by the magnet. For example, a fluid layer can include a lysis buffer to lyse cells, and cellular components can become bound to or otherwise associated with a surface of the magnetizing particles. Lysing cells in a fluid can modify the fluid sample and thus modify or interact with a surface of magnetizing particles, e.g., the cellular component binds or becomes otherwise associated with a surface of the magnetizing particles. In one example, the association between the biological component and the magnetizing particles (or other particulate substrate) can alternatively include surface adsorption, electrostatic attraction, or some other attraction between the biological component and the surface of the particulate substrate. In yet other examples, a fluid layer that would be considered to interact with the magnetizing particles could be a wash fluid layer to trap contaminates from a sample fluid and/or remove contaminates from an exterior surface of the magnetizing particles, a surfactant fluid layer to coat the magnetizing particles, a dye fluid layer to introduce visible or other markers to the fluid or surface, an elution fluid layer to remove the biological component from the magnetizing particles following extraction from the biological sample, a labeling fluid layer for binding labels to the biological component such as a fluorescent label (either attached to the magnetizing particles or unbound thereto), a reagent fluid layer to prep a biological component for further analysis such as a master mix fluid layer to prep a biological component for PCR, and so on.

As used herein, a plurality of items, structural elements, compositional elements, and/or materials may be presented in a common list for convenience. However, these lists should be construed as though individual members of the list are individually identified as separate and unique members. Thus, no individual member of such list should be construed as a de facto equivalent of any other member of the same list solely based on presentation in a common group without indications to the contrary.

Concentrations, amounts, and other numerical data may be expressed or presented herein in a range format. A range format is used merely for convenience and brevity and thus should be interpreted flexibly to include the numerical values explicitly recited as the limits of the range, and also to include individual numerical values or sub-ranges encompassed within that range as if numerical values and sub-ranges are explicitly recited. As an illustration, a numerical range of “about 1 wt % to about 5 wt %” should be interpreted to include the explicitly recited values of about 1 wt % to about 5 wt %, and also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting one numerical value. Furthermore, such an interpretation should apply regardless of the breadth of the range or the characteristics being described.

While the present technology has been described with reference to certain examples, various modifications, changes, omissions, and substitutions can be made without departing from the spirit of the disclosure. The disclosure is not limited other than by the scope of the following claims.

1. A sample preparation blister pack comprising:
a plurality of reservoirs formed as blisters having an actuatable barrier layer and a seal barrier layer, with contents of the plurality of reservoirs situated between the actuatable barrier layer and the seal barrier layer,
wherein the contents are adapted to facilitate isolation of a biological component from a biological sample,
wherein the individual reservoirs facilitate release of the contents through the seal barrier layer upon actuation of the actuatable barrier layer,
wherein the sample preparation blister pack has a width and a length, with the plurality of reservoirs aligned along the length, and
wherein a first reservoir of the plurality of reservoirs contains an inert mechanical fluid and a second reservoir of the plurality of reservoirs contains a reagent, a buffer, or a combination thereof.

2. The sample preparation blister pack of claim 1, wherein the inert mechanical fluid is a non-Newtonian plugging fluid.

3. The sample preparation blister pack of claim 1, wherein the inert mechanical fluid is a gas.

4. The sample preparation blister pack of claim 1, wherein the inert mechanical fluid is a non-Newtonian plugging fluid and wherein the sample preparation blister pack further comprises a third reservoir containing a gas.

5. The sample preparation blister pack of claim 1, wherein the seal barrier layer includes a plurality of opening features, wherein individual opening features are adapted to provide an opening to release contents of the individual reservoirs into a sample preparation cartridge channel upon actuation of the actuatable barrier adjacent to the respective individual reservoirs, wherein the plurality of opening features are lined up along the length of the sample preparation blister pack.

6. A sample preparation blister pack comprising:
a plurality of reservoirs formed as blisters having an actuatable barrier layer and a seal barrier layer,
wherein individual reservoirs contain a fluid between the actuatable barrier layer and the seal barrier layer, and wherein the individual reservoirs are adapted to release the fluid through the seal barrier layer upon actuation of the actuatable barrier layer, and
wherein the plurality of reservoirs comprise (i) a reservoir containing an inert mechanical fluid and (ii) a liquid reservoir containing a liquid comprising a reagent, a buffer, or a combination thereof.

7. The sample preparation blister pack of claim 6, wherein the reservoir containing the inert mechanical fluid is a non-Newtonian plugging fluid reservoir containing a non-Newtonian plugging fluid.

8. The sample preparation blister pack of claim 7, wherein the non-Newtonian plugging fluid is a Bingham plastic, a viscoplastic, or a shear thinning fluid.

9. The sample preparation blister pack of claim 6, wherein the reservoir containing the inert mechanical fluid is a gas reservoir containing a gas.

10. The sample preparation blister pack of claim 6, wherein the liquid reservoir is a wash buffer reservoir containing a wash buffer.

11. The sample preparation blister pack of claim 10, wherein the plurality of reservoirs further comprises a reconstitution buffer reservoir containing a reconstitution buffer for reconstituting a lyophilized master mix reagent.

12. The sample preparation blister pack of claim 11, wherein a hole is preformed in the seal barrier layer of the gas reservoir.

13. The sample preparation blister pack of claim 6, further comprising a label layer affixed on the seal barrier layer, wherein the label layer comprises individual openings at the individual reservoirs to admit fluids released from the individual reservoirs.

14. The sample preparation blister pack of claim 13, further comprising:
a pressure-sensitive adhesive layer on the label layer opposite from the seal barrier layer, wherein the pressure-sensitive adhesive layer comprises individual openings aligned with the individual openings of the label layer; and
a supply channel connected to an individual opening having a width greater than a width of the supply channel.

15. A sample preparation cartridge module comprising:
a capillary output channel;
a cartridge wall comprising a plurality of supply channels fluidly connected to the capillary output channel; and
a blister pack affixed to the cartridge wall, the blister pack comprising a plurality of reservoirs formed as blisters having an actuatable barrier layer and a seal barrier layer, wherein individual reservoirs contain a fluid between the actuatable barrier layer and the seal barrier layer, and wherein the individual reservoirs are adapted to release the fluid through the seal barrier layer into individual supply channels upon actuation of the actuatable barrier layer, wherein the plurality of reservoirs comprise a reservoir containing an inert mechanical fluid and a liquid reservoir containing a liquid comprising a reagent, a buffer, or a combination thereof.

16. The sample preparation cartridge module of claim 15,
wherein the reservoir containing the inert mechanical fluid is a gas reservoir containing a gas, and
wherein the gas reservoir is connected to the capillary output channel by a supply channel such that fluid within the capillary output channel is ejected by the gas when the actuatable barrier of the gas reservoir is actuated.

17. The sample preparation cartridge module of claim 15, wherein the reservoir containing the inert mechanical fluid is a non-Newtonian plugging fluid reservoir containing a non-Newtonian plugging fluid

18. A method of making a sample preparation cartridge module, the method comprising:
affixing a blister pack onto a cartridge wall of a cartridge module body comprising a capillary output channel and the cartridge wall,
wherein the cartridge wall comprises a plurality of supply channels fluidly connected to the capillary output channel,
wherein the blister pack comprises a plurality of reservoirs formed as blisters having an actuatable barrier layer and a seal barrier layer,
wherein individual reservoirs contain a fluid between the actuatable barrier layer and the seal barrier layer, and wherein the individual reservoirs are adapted to release the fluid through the seal barrier layer into individual supply channels upon actuation of the actuatable barrier layer, and
wherein the plurality of reservoirs comprise a reservoir containing an inert mechanical fluid and a liquid reservoir containing a liquid comprising a reagent, a buffer, or a combination thereof.

19. The method of claim 18,
wherein the blister pack further comprises a label layer affixed on the seal barrier layer, wherein the label layer comprises individual openings at the individual reservoirs to admit fluids released from the individual reservoirs, and
wherein affixing the blister pack onto the cartridge wall comprises using a pressure-sensitive adhesive layer comprising individual openings aligned with the individual openings of the label layer, wherein the pressure-sensitive adhesive layer further includes a supply channel opening aligned with a supply channel of the cartridge wall.

20. The method of claim 18,
wherein the liquid reservoir is a wash buffer reservoir containing a wash buffer,
wherein the plurality of fluid reservoirs further comprises a reconstitution buffer reservoir containing a reconstitution buffer for reconstituting a lyophilized master mix reagent, and
wherein the plurality of supply channels comprises a reconstitution buffer supply channel connected to the reconstitution buffer reservoir and having a lyophilized master mix reagent held within the reconstitution buffer supply channel.
